(19) United States
(12) Patent Application Publication
(10) Pub. No.: US 2011/0243692 A1
(43) Pub. Date: Oct. 6, 2011

(54) MATERIAL COLLECTION BODY

(75) Inventors: Jean FORTIN, St-Cyrille (CA); Clermont Fortin, Notre-Dame-Du-Bon-Conseil (CA)

(73) Assignee: 7503687 Canada inc., Drummondville (CA)

(21) Appl. No.: 12/963,586

(22) Filed: Dec. 8, 2010

Related U.S. Application Data
(60) Provisional application No. 61/319,908, filed on Apr. 1, 2010.

(51) Int. Cl. B65F 3/20; B65F 3/28; B30B 9/00; B30B 15/00

(52) U.S. Cl. 414/352; 414/406; 100/179; 100/100

(57) ABSTRACT

The present document describes a kit for installation in a collection body, comprising a material receiver, for installation between the upper wall and the lower wall of the collection body, a tamping mechanism to allow the translation of materials disposed on the receptor and their discharge in the body, a packing mechanism to push the materials disposed in the body and compacting them.

### CROSS-REFERENCE TO RELATED APPLICATIONS

This application claims priority of U.S. provisional patent application No. 61/319,908 filed on Apr. 1, 2010 and Canadian patent application No. N/A filed on Nov. 25, 2010, the specification of which is hereby incorporated by reference.

### BACKGROUND

(a) Field

The subject matter disclosed generally relates to a vehicle for the collection, the transportation and the compaction of materials.

(b) Related Prior Art

At this point, different types of collection bins allow the collection, the transportation and the compaction of recyclable or non-recyclable materials. In general, these bins include a cargo bed of prismatic shape and three loading options: 1) opening allowing lateral loading, 2) opening allowing rear loading, and 3) opening allowing front loading. Typically, these bins also allow a mechanism for loading and discharging of containers to the inside of the waste bin collection. These bins are also equipped with a press mechanism for the compaction of refuse and waste, allowing them to be ejected out of the dumpster.

In addition, the bins for collection and compaction of waste material currently have the option to allow the loading of waste material through smaller containers parked in the streets. This specific function allows the lifting and unloading of the recyclable and non-recyclable materials in a proper compartment of the cargo bed.

In fact, after the analysis of the different models of bins for collection and compaction of waste materials, it is possible to identify several areas that could be significantly improved. First, recycled or non-recycled materials, which are collected in the municipalities, are most of the time excessively heavy. Hence, the forces applied on the waste body by the waste materials falling from a waste bin during collection, but also the forces applied on the bin during the compaction of the waste materials, increase obviously the damage on the main equipment. To compensate for this deficiency, the waste collection equipments of the prior art are mostly built from strong and very heavy materials, which greatly increases the total weight of the waste material collection bin. Such an increase in the total mass of the vehicle results in an increase of the fuel consumption of the vehicle and in a reduction of the payload.

On the other hand, after analyzing the different models of collection and compaction waste material bins, there is shown in the prior art compaction mechanisms using a large hydraulic power supply given a limited volume of the bin which requires a greater compaction.

### SUMMARY

According to an embodiment, there is provided a kit for installation in a collection body, comprising a material receiver, for installation between the upper wall and the lower wall of the collection body, a tamping mechanism to allow the translation of materials disposed on the receptor and their discharge in the body, a packing mechanism to push the disposed materials in the body and compact them.

According to another embodiment, there is provided a collection body comprising a material receiver, for installation between the upper wall and the lower wall of the collection body, a tamping mechanism to allow the translation of materials disposed on the receptor and their discharge in the body, a packing mechanism to push the disposed materials in the body and compact them.

According to another embodiment, there is provided a material collection vehicle comprising a body fixed to a vehicle frame, the body comprising a material receiver, for installation between the upper wall and the lower wall of the collection body, a tamping mechanism to allow the translation of materials disposed on the receptor and their discharge in the body, a packing mechanism to push the disposed materials in the body and compact them.

According to another embodiment, there is provided a cylindrical collection body comprising a cylindrical body including an opening for the discharge of the materials and an articulated arm associated with the body to capture a container of the material and to dispose them in said body by the opening.

According to another embodiment, the material receiver is a platform.

According to another embodiment, the tamping mechanism comprises a tamping ram.

According to another embodiment, the packing mechanism comprises a packing ram.

According to another embodiment, the packing ram allow the removal of said materials from said body without lifting said body.

According to another embodiment, the kit further comprises guides for the tamping mechanism and the packing mechanism.

According to another embodiment, the guides are one-piece guides.

According to another embodiment, the guides are extruded.

According to another embodiment, the collection body is of cylindrical shape.

According to another embodiment, the articulated arm unfolds and matches with the outer surface of said body when said materials are discharged.

According to another embodiment, the opening is for back loading, front loading or side loading of said materials.

According to another embodiment, the arm is fixed to a support, and the support is fixed to the vehicle frame.

According to another embodiment, the arm is fixed to the body.

According to another embodiment, the collection body further comprises an hydraulic reservoir juxtaposed to said body.

According to another embodiment, there is provided a method for compacting materials into a collection body having an opening and a drop point below the opening, comprising the steps of:

a) tamping materials disposed in the body for distancing them from the drop point to avoid a piling up at the drop point; and

b) compacting the materials packed in the body.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1A and 1B illustrate a schematic front view of a material collection body according to an embodiment, where the body is having an articulated arm for transporting a material container trough the collection body.

FIG. 2 is a schematic view of the collection body of FIG. 1B, where the articulated arm unfolds for discharging the materials from the material container.

FIG. 3 is a tridimensional view that illustrates the tamping mechanism and the packing mechanism of the two stages mechanism according to an embodiment, at the resting position.

FIG. 4 is a similar view of FIG. 3 when the tamping mechanism is in position of tamping and the packing mechanism is in position of packing.

FIG. 5 is a tridimensional view of the tamping ram.

FIG. 6 is a tridimensional view of the packing ram.

FIG. 7 is a tridimensional view of the cylindrical collection body showing the internal guides of the tamping and the compacting ram.

FIG. 8 is a side view of the collection body showing the material evacuation door in a closed position.

FIG. 9 is a view of the material evacuation door in an opened position.

FIG. 10 is a side view of an hydraulic reservoir juxtaposed to the collection body.

It will be noted that throughout the appended drawings, like features are identified by like reference numerals.

### DETAILED DESCRIPTION OF THE PREFERRED EMBODIMENTS

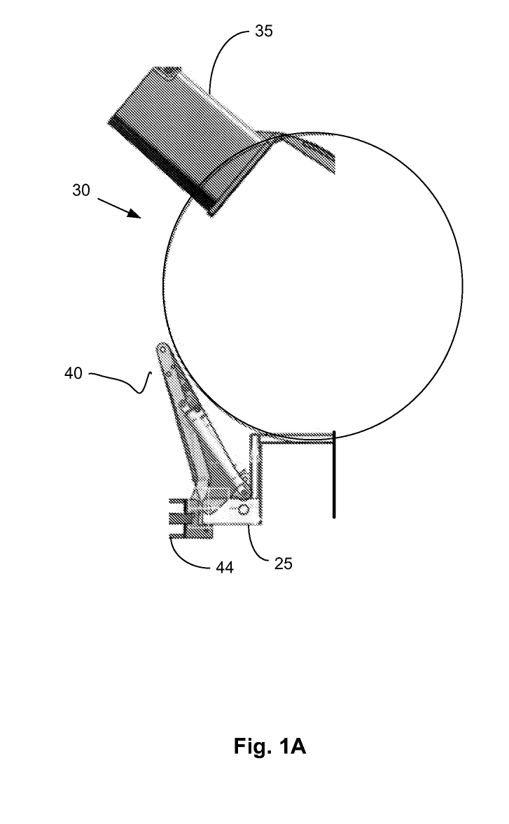

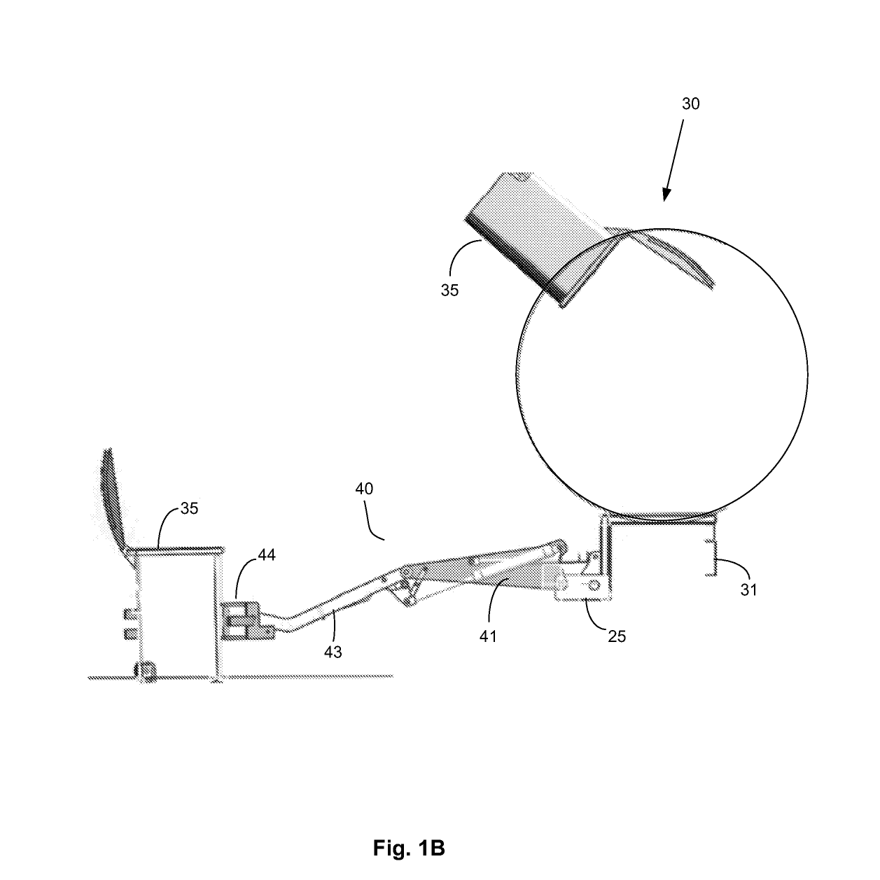

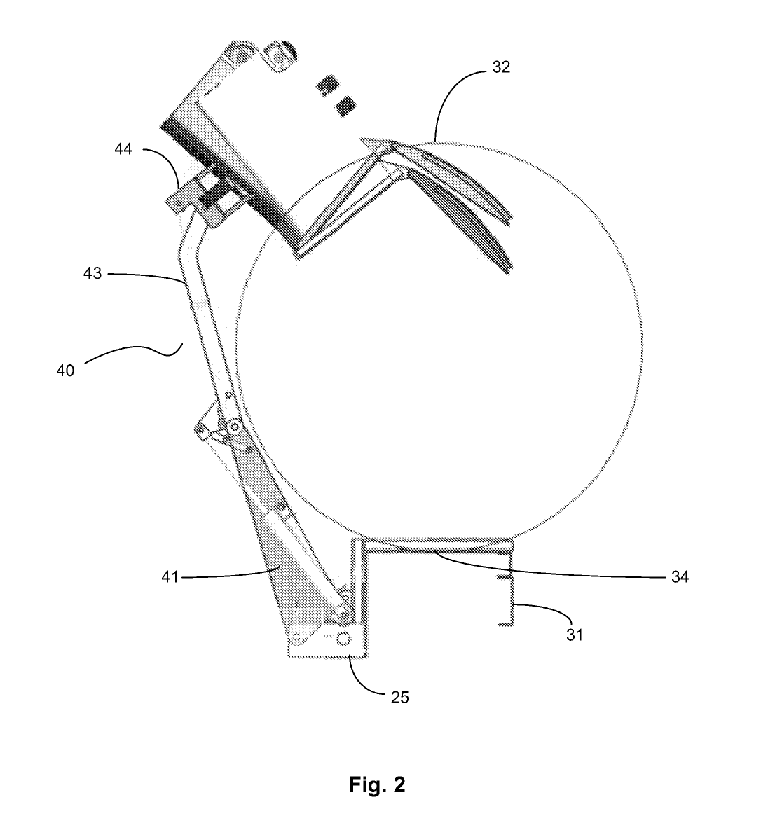

Referring now to the drawings, and more particularly to FIGS. 1A, 1B and 2, the collection body 30 is of a cylindrical shape and is provided with an articulated arm 40 for transporting a material container 35 to the collection body 30. The collection body 30 is disposed with well known techniques on the chassis 31 of a vehicle. As shown in FIG. 2, the collection body 30 may include an upper wall 32 and a lower wall 34. The collection body 30, illustrated as being cylindrical on FIGS. 1A, 1B and 2, may be made, without limitations, of steel, aluminum, or any suitable materials as it is well known by those skilled in the art.

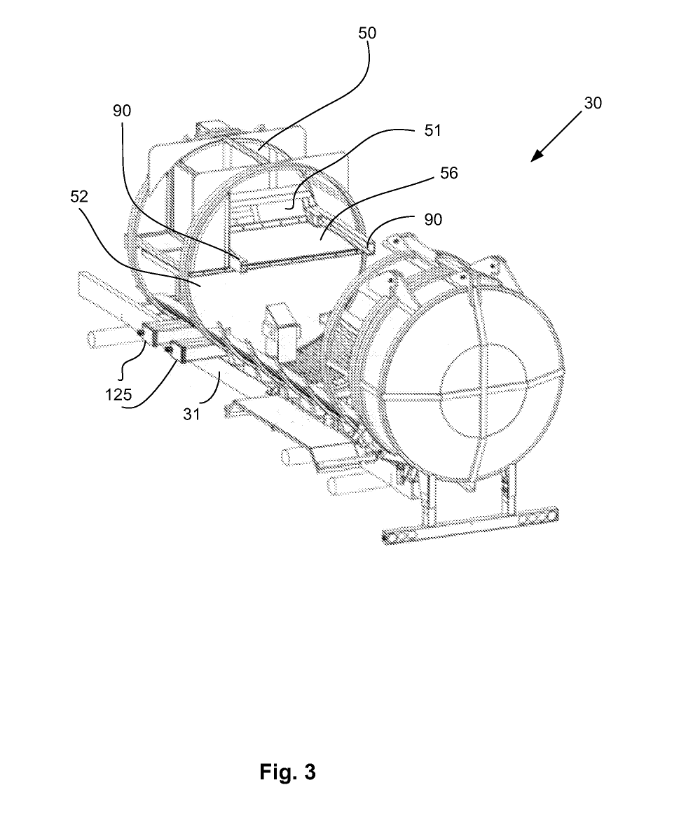

The articulated arm 40 of the collection body 30 is fixed to be deployed from a closed position, illustrated in FIG. 1A, to a position for capturing a container, illustrated in FIG. 1B, to a discharge position, illustrated in FIG. 2, to allow the passage of materials from the material container 35 to the collection body 30 through the opening 50 (FIG. 3) for unloading or discharging materials into the collection body 30. As shown in FIG. 2, the articulated arm 40 matches intimately, although this is not absolutely essential, with the cylindrical portion of the collection body 30. Obviously, the three positions of the articulated arm 40, illustrated in FIGS. 1A, 1B and 2, correspond to useful positions. When the articulated arm 40 is completely at a resting position, the articulated arm 40 is completely folded over the support 25, as shown in FIG. 1A. The positioning of the support 25 of the articulated arm 40, which is under the chassis 31 of the vehicle, prevents from the sway of the vehicle and the collection body 30 during the operation.

Still referring to FIGS. 1A, 1B and 2, there is shown the articulated arm 40. More specifically, the articulated arm 40 may include a triangular member 41 on a support 25, as shown in FIGS. 1B and 2, and a slightly curved link 43, attached to a hooking member 44, which is intended to capture the material container 35. It will be expected that the curvature of the curved link 43 is obviously intended to match closely along the outer wall of the cylindrical collection body 30, as it is clearly shown in FIG. 2 in a discharging position.

Referring now to FIG. 3, the collection body 30 may include a material tamping mechanism 51 and a material packing mechanism 52, which will now be described in details. As shown in FIGS. 1A, 1B and 2, the collection body 30 is of a cylindrical shape, but it is understood that those skilled in the art may adapt the tamping and the packing mechanisms 51 and 52 to any other forms, including prismatic, elliptical and the like. As shown in FIG. 3, the materials are discharged through the opening 50, located on the upper wall 32 of the collection body 30 and more specifically, the opening 50 may be located on the front side of the collection body 30. The opening 50 may also be located at various locations between the upper wall 32 and the lower wall 34 as at the back side, on top or side of the collection body 30.

To avoid excessive forces associated with the materials falling on the lower wall 34 of the collection body 30, there is provided a receiving plate 56, which is an horizontal plate for receiving materials discharged from the material container 35 via the opening 50 of the collection body 30 (FIG. 3).

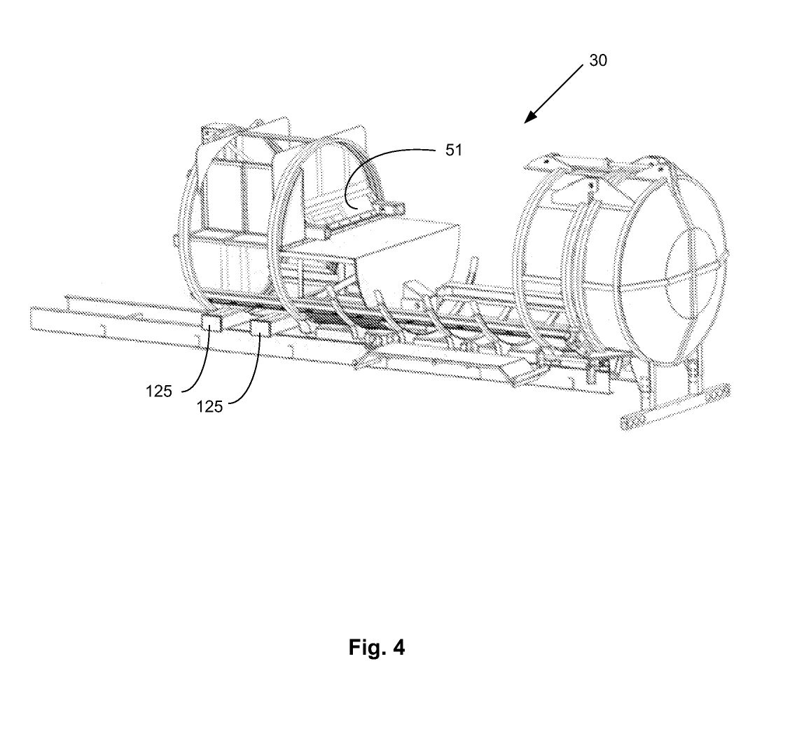

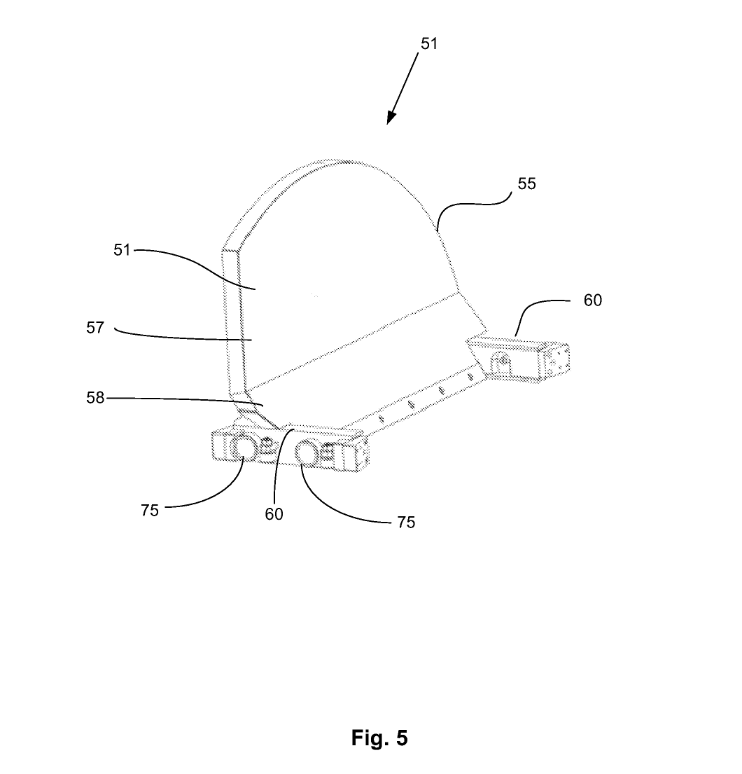

As shown in FIG. 3, the fixed receiving plate 56 may be positioned between the upper wall 32 and the lower wall 34. The tamping mechanism 51 will now be described in details. Referring to FIG. 5, the tamping mechanism 51 includes a tamping ram 55 and a bearing seat 60, arranged to move back and forth on the material receiving plate 56 (FIG. 3). For a preferred embodiment, although this is not essential, the tamping ram 55 is semi-circular as shown in FIG. 5, and includes a vertical upper portion 57 and a lower portion 58, which is slightly forwardly inclined, as can shown in both FIGS. 3 and 4. In this sense, tamping materials beyond the receiving plate 56 is preferably realized with the tamping ram 55 as shown in FIG. 4. However, those skilled in the art can obviously conceive any other structure tamping ram 55, without departing from the scope of the present invention.

On the basis of bearing seats 60, it moves on the axial rollers 75, mounted with well-known techniques, and more details will be later available in this description.

On the other hand, FIG. 3 illustrates a packing mechanism 52. Indeed, when the materials have been packed on the lower wall 34 of the collection body 30 by the tamping mechanism 51, the packing mechanism 52 will compress those materials.

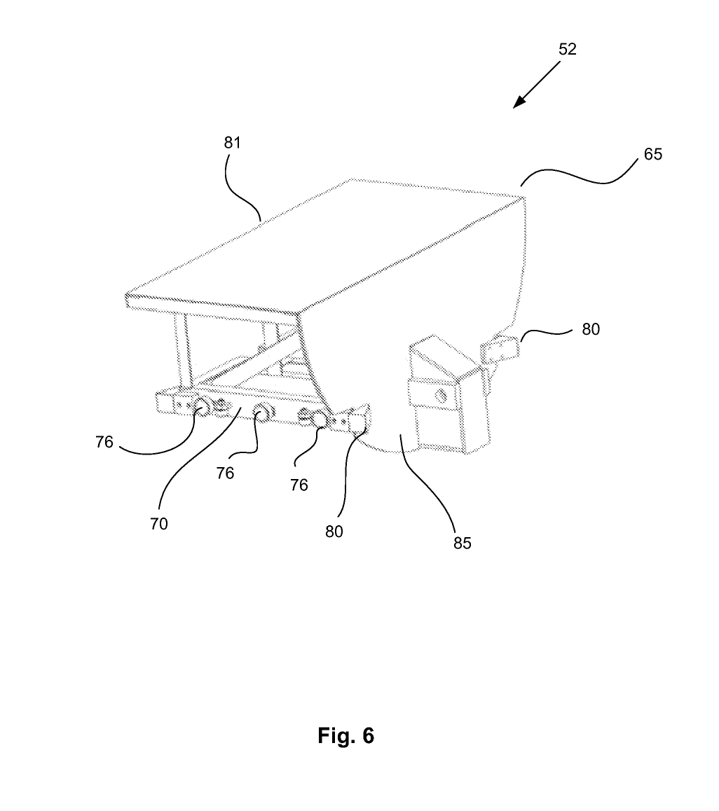

The packing mechanism 52 may include a packing ram 65 and the bearing seats 70 (FIG. 6). The packing ram 65 must be able to move back and forth along the lower wall 34 of the collection body 30, as it will be shown later.

Particularly referring to FIGS. 3, 4 and 6, it will be shown that because of the cylindrical structure of the collection body 30, the packing ram 65 is of a generally semi-circular shape (FIG. 6). Referring to FIG. 6, the packing ram 65 has a top horizontal plate 81, a vertical shielding plate 85, as well as axial rollers 76, allowing movement of the packing ram 65 along the lower wall 34 of the collection body 30. There is provided a top horizontal plate 81 to avoid the materials, when in the tamping mechanism 51 and in the packing mechanism simultaneously, to fall behind the packing ram 65. In addition, scrappers or a sealing joint 80 are also installed in the interstices between the different parts.

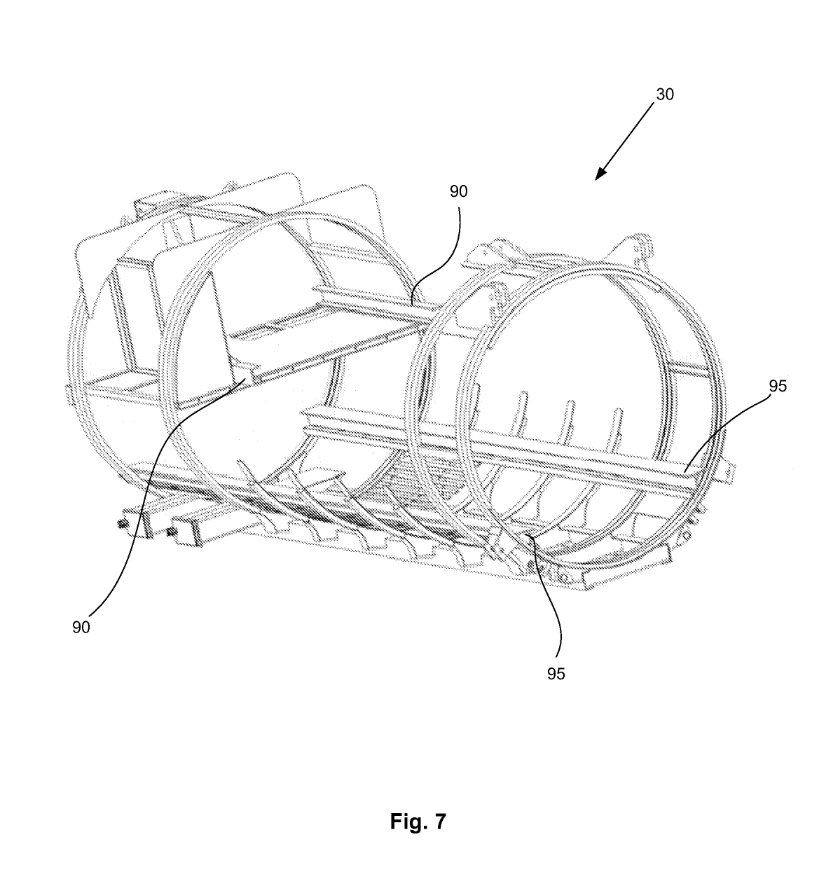

As regards to the movement of the packing mechanism 52, reference is primarily made to FIGS. 3 and 4, and to FIG. 7 for the internal guides 95 of the packing mechanism 52, which are not shown in FIGS. 3 and 4.

To ensure efficient movement of the tamping mechanism 51 and the packing mechanism 52, along a portion of the receiving plate 56 and the lower wall 34 of the collection body 30, there is provided internal guides 90 for the tamping mechanism 51, and more particularly for the tamping ram 55. There is also provided internal guides 95 for the packing mechanism 52, and more particularly for the packing ram 65, as it is shown in FIG. 7. Still referring to FIG. 7, it is shown that the internal guides 90 may be U-shaped and directed both inward for forming the rails. On the other hand, the internal guides 95, by their location on the lower wall 34 of the collection body 30, have a particular structure illustrated in FIG. 7. Of course, this structure may vary depending on the choice of those skilled in the art, and will obviously be part of the present invention.

In operation, as an example, the tamping mechanism 51 is activated as required for each material discharge through the opening 50. The tamping of material by tamping ram 55 is effected by rolling through the axial rollers 75 in the internal guides 90 allowing the optimization of the translational motion. The two rams 55 and 65 move by rolling rather than by friction, as in the prior art, thereby reducing friction.

Having firstly a tamping mechanism 51 minimizes the use of the packing mechanism 52. This reduces the demand on the operation of an hydraulic equipment to avoid the unnecessary stress on the structure, the unnecessary expenditure of energy and thereby, the amount of discharge of carbon dioxide in the air.

On the other hand, as shown in FIG. 3, the packing mechanism 52 is at a resting position under the receiving plate 56, allowing the reception of materials. More particularly, the packing mechanism 52 is activated as required, for example, every five cycles processed by the tamping mechanism 51. The packing of material by the packing ram 65 is effected by rolling the packing mechanism through the axial rollers 76 in the internal guides 95 allowing an optimized translation movement.

In sum, referring to FIG. 3, it is shown that, in general, the translational movement of the tamping ram 55 is possible using the internal guides 90, thus tamping the material into the collection body 30. On the other hand, the translational movement of the packing ram 65 is possible by using the internal guides 95, thus allowing the compaction of materials (FIG. 4). In addition, the receiving plate 56 may include openings holes behind the tamping ram 55, than avoiding the accumulation of materials behind the tamping ram 55, allowing a translation movement of materials, towards the lower wall 34 of the collection body 30 to the two cleaning doors 125.

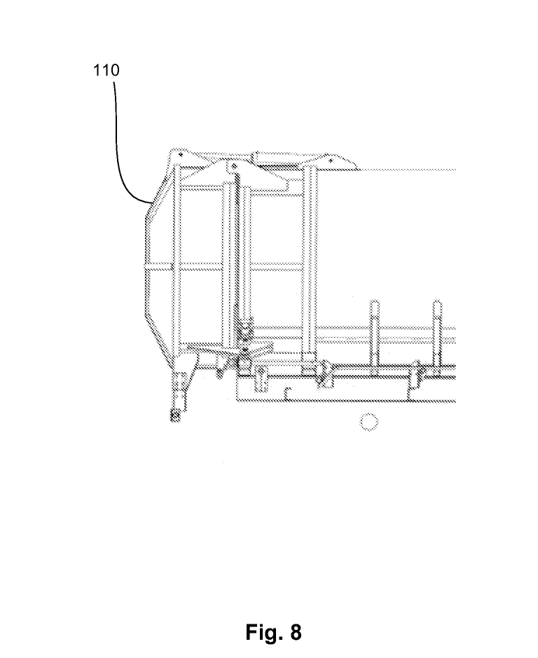

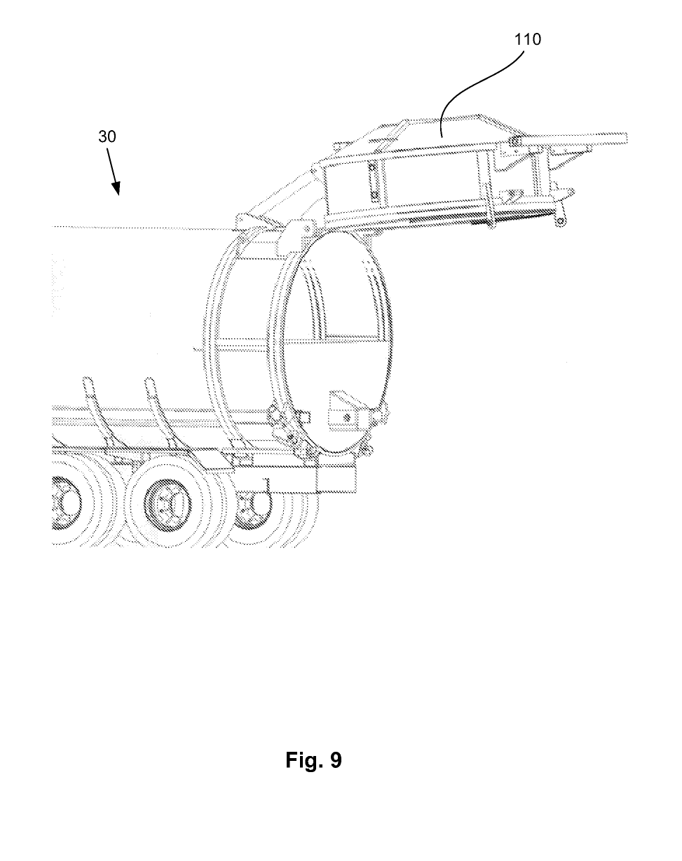

Referring now to FIG. 8, there is shown the door 110 of the collection body 30 in the closed position. The door 110 still, may have the shape of a container that can contain materials. This feature adds to the volume of the collection body 30. As discussed in FIGS. 8 and 9, the opening and the closing of the door 110 is done in a manner known by those skilled in the art.

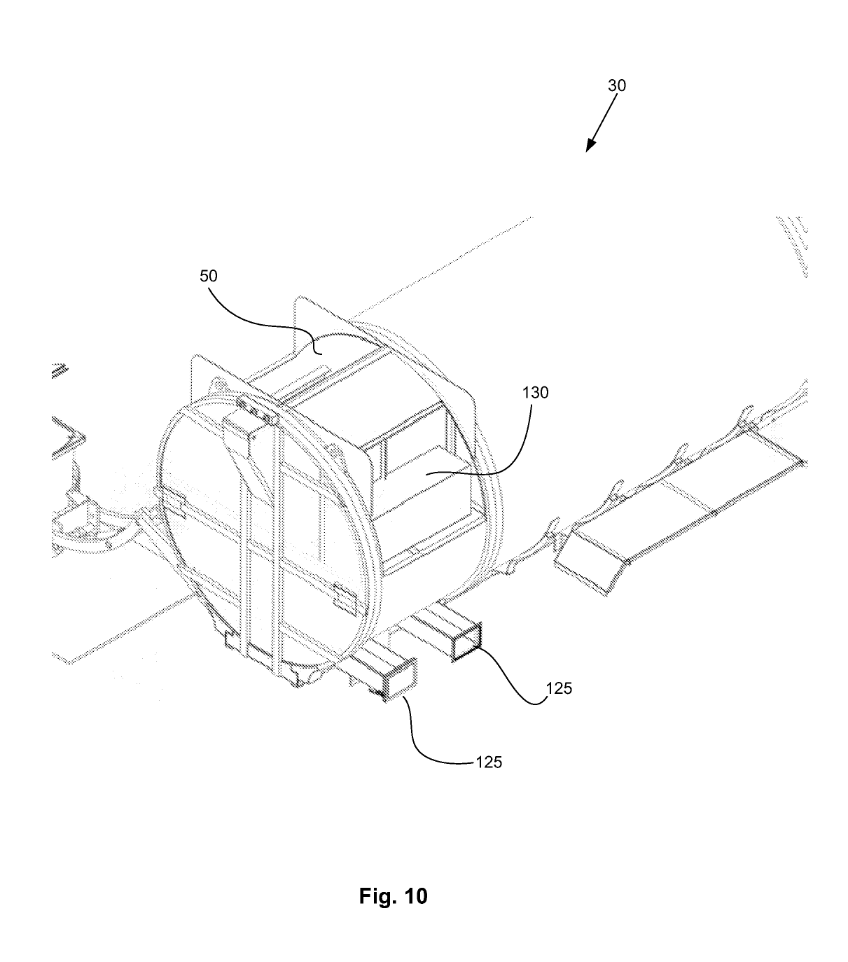

The collection body 30 may include an hydraulic reservoir 130 (FIG. 10) next to the collection body 30.

The cylindrical structure simplifies the construction of the collection body 30 and increases its effective volume, decreases the weight of the collection body 30 and thereby increases its payload. The cylindrical structure of the collection body 30 has a greater volume of cargo (42 cubic yards) over the prior art (37 cubic yards) to thereby reduce the rate of compaction necessary to achieve the permissible load. Having a larger volume requires less compaction to achieve the payload and allow more loading of low density materials difficult to compact.

Having a two stages packing mode including a tamping mechanism 51 and a packing mechanism 52 reduces the dimensions of the loading compartment for a greater payload volume and reduces the need for powerful compaction, resulting in energy savings. Furthermore, the tamping mechanism 51 and the packing mechanism 52 prevent the damages to the collection body 30 during the discharge of the materials and reduce the potential structural and mechanical failures.

While preferred embodiments have been described above and illustrated in the accompanying drawings, it will be evident to those skilled in the art that modifications may be made without departing from this disclosure. Such modifications are considered as possible variants comprised in the scope of the disclosure.

1. Kit for installation in a collection body, comprising a material receiver, for installation between the upper wall and the lower wall of the collection body, a tamping mechanism to allow the translation of materials disposed on said receptor and their discharge in the body, a packing mechanism to push the disposed materials in the body and compact them.

2. The kit according to claim 1, wherein said material receiver is a platform.

3. The kit according to claim 2, wherein said tamping mechanism comprises a tamping ram.

4. The kit according to claim 3, wherein said packing mechanism comprises a packing ram.

5. The kit according to claim 4, wherein said packing ram allow the removal of said materials from said body without lifting said body.

6. The kit according to claim 1, further comprising guides for the tamping mechanism and the packing mechanism.

7. The kit according to claim 6, wherein said guides are one-piece guides.

8. The kit according to claim 7, wherein said guides are extruded.

9. A collection body comprising a material receiver, for installation between the upper wall and the lower wall of the collection body, a tamping mechanism to allow the translation of materials disposed on said receptor and their discharge in the body, a packing mechanism to push the disposed materials in the body and compact them.

10. The collection body according to claim 9, wherein said body is of cylindrical shape.

11. The collection body according to claim 9, wherein said material receiver is a platform.

12. The collection body according to claim 9, wherein said tamping mechanism comprises a tamping ram.

13. The collection body according to claim 9, wherein said packing mechanism comprises a packing ram.

14. The collection body according to claim 13, wherein said packing ram allow the removal of said materials from said body without lifting said body.

15. The collection body according to claim 9, further comprising an hydraulic reservoir juxtaposed to said body.

16. The collection body according to claim 9, further comprising guides for the tamping mechanism and the packing mechanism.

17. The collection body according to claim 16, wherein said guides are one-piece guides.

18. The collection body according to claim 17, wherein said guides are extruded.

19. A cylindrical collection body comprising:
a cylindrical body including an opening for the discharge of the materials; and
an articulated arm associated with said body to capture a container of said material and to dispose them in said body by said opening.

20. The collection body according to claim 19, wherein said articulated arm unfolds and matches with the outer surface of said body when said materials are discharged.

21. The collection body according to claim 19, wherein said opening is for back loading, front loading or side loading of said materials.

22. The collection body according to claim 19, wherein said arm is fixed to a support, wherein said support is fixed to the vehicle frame.

23. The collection body according to claim 19, wherein said arm is fixed to the body.

24. A material collection vehicle comprising a body fixed to a vehicle frame, said body comprising a material receiver, for installation between the upper wall and the lower wall of the collection body, a tamping mechanism to allow the translation of materials disposed on said receptor and their discharge in the body, a packing mechanism to push the disposed materials in the body and compact them.

25. The material collection vehicle according to claim 24, wherein said body is of cylindrical shape.

26. The material collection vehicle according to claim 24, wherein said material receiver is a platform.

27. The material collection vehicle according to claim 24, wherein said tamping mechanism comprises a tamping ram.

28. The material collection vehicle according to claim 24, wherein said packing mechanism comprises a packing ram.

29. The material collection vehicle according to claim 24, wherein said packing ram allow the removal of said materials from said body without lifting said body.

30. The material collection vehicle according to claim 24, further comprising an articulated arm associated with said body to capture a container of said material and to dispose them in said body by said opening.

31. The material collection vehicle according to claim 30, wherein said articulated arm unfolds and matches with the outer surface of said body when said materials are discharged.

32. The material collection vehicle according to claim 30, wherein said arm is fixed to the vehicle frame.

33. The material collection vehicle according to claim 30, wherein said arm is fixed to a support, wherein said support is fixed to the vehicle frame.

34. The material collection vehicle according to claim 30, wherein said arm is fixed to the body.

35. The material collection vehicle according to claim 25, further comprising an hydraulic reservoir juxtaposed to said body.

36. The material collection vehicle according to claim 25, further comprising guides for the tamping mechanism and the packing mechanism.

37. The material collection vehicle according to claim 36, wherein said guides are one-piece guides.

38. The material collection vehicle according to claim 37, wherein said guides are extruded.

39. A method for packing materials into a collection body having an opening and a drop point below the opening, comprising the steps of:
a) tamping materials disposed in the body for distancing from the drop point to avoid a piling up at the drop point;
b) compacting the materials packed in the body.
